(19) United States
(12) Patent Application Publication
(10) Pub. No.: US 2025/0301089 A1
(43) Pub. Date: Sep. 25, 2025

(54) PRINTING SYSTEM AND PRINTING METHOD

(71) Applicant: FUJIFILM Business Innovation Corp., Tokyo (JP)

(72) Inventors: Yuki ANDO, Kanagawa (JP); Naohiro TATEISHI, Kanagawa (JP); Tetsuhiro INOUE, Kanagawa (JP)

(73) Assignee: FUJIFILM Business Innovation Corp., Tokyo (JP)

(21) Appl. No.: 18/822,302

(22) Filed: Sep. 2, 2024

(30) Foreign Application Priority Data
Mar. 25, 2024 (JP) 2024-048755

(51) Int. Cl. H04N 1/387

(52) U.S. Cl. CPC H04N 1/3872

(57) ABSTRACT

A printing system includes a printing unit that prints a print image on a recording medium and prints a position adjustment image corresponding to each page of the print image on the recording medium, a reading unit that reads the position adjustment image printed by the printing unit, an adjustment unit that adjusts a printing position of each page of the print image printed by the printing unit on the recording medium on the basis of the position adjustment image read by the reading unit, and a printing control unit that performs control to perform printing while providing an interval between a printing timing of a first page and a printing timing of a second page of the print image such that a printing position of the second page of the print image is adjusted by the adjustment unit on the basis of the position adjustment image of the first page of the print image.

### CROSS-REFERENCE TO RELATED APPLICATIONS

This application is based on and claims priority under 35 USC 119 from Japanese Patent Application No. 2024-048755 filed Mar. 25, 2024.

### BACKGROUND

### (i) Technical Field

The present invention relates to a printing system and a printing method.

### (ii) Related Art

JP2018-010115A discloses an image forming apparatus including an image forming unit that forms an image and prints the image on a transfer medium, and a control unit that manages a job and controls image formation in the image forming unit, wherein the control unit has a real-time adjustment function of acquiring a reading result of an adjustment image by printing the adjustment image on the transfer medium during job output of printing the image on the transfer medium on the basis of the job by the image forming unit, and performing adjustment of the image quality of the image formed by the image forming unit on the basis of the reading result in real time, and in a case where a job of not performing the real-time adjustment and a job of performing the real-time adjustment are continuous in an execution job, the control unit acquires a reading result by printing the adjustment image on the transfer medium in the job of not performing the real-time adjustment, and applies the image quality adjustment to the job of performing the real-time adjustment on the basis of the reading result.

### SUMMARY

Aspects of non-limiting embodiments of the present disclosure relate to a printing system and a printing method that reduce the number of print images of which printing positions are not adjusted, as compared with a case where a second page of a print image is printed by a printing unit before a reading unit reads a position adjustment image of a first page of the print image.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a printing system including: a printing unit that prints a print image on a recording medium and prints a position adjustment image corresponding to each page of the print image on the recording medium; a reading unit that reads the position adjustment image printed by the printing unit; an adjustment unit that adjusts a printing position of each page of the print image printed by the printing unit on the recording medium on the basis of the position adjustment image read by the reading unit; and a printing control unit that performs control to perform printing while providing an interval between a printing timing of a first page and a printing timing of a second page of the print image such that a printing position of the second page of the print image is adjusted by the adjustment unit on the basis of the position adjustment image of the first page of the print image.

### BRIEF DESCRIPTION OF THE DRAWINGS

Exemplary embodiment(s) of the present invention will be described in detail based on the following figures, wherein:

FIG. 1 is a diagram showing a schematic configuration of a printing system according to an exemplary embodiment;

FIG. 2 is a plan view showing a printed material on which a position adjustment image according to the exemplary embodiment is printed;

FIG. 3 is an explanatory diagram illustrating the operation of the printing system that starts printing a subsequent printed material before reading the position adjustment image from a printed material of a first page;

FIG. 4 is a graph indicating the relationship between the number of printed sheets of a printed material and the misalignment amount of a position adjustment image M read from the printed material by an image reader in the printing system shown in FIG. 3;

FIG. 5 is an explanatory diagram illustrating the operation of the printing system that calculates a moving average value of a plurality of pieces of misalignment information and calculates a correction value for the printing position of an image on the basis of the calculated moving average value;

FIG. 6 is a graph indicating the relationship between the number of printed sheets of a printed material and the misalignment amount of a position adjustment image read from the printed material by an image reader in the printing system shown in FIG. 5;

FIG. 7 is a block diagram showing the hardware configuration of the printing system shown in FIG. 1;

FIG. 8 is a functional block diagram of the printing system shown in FIG. 1;

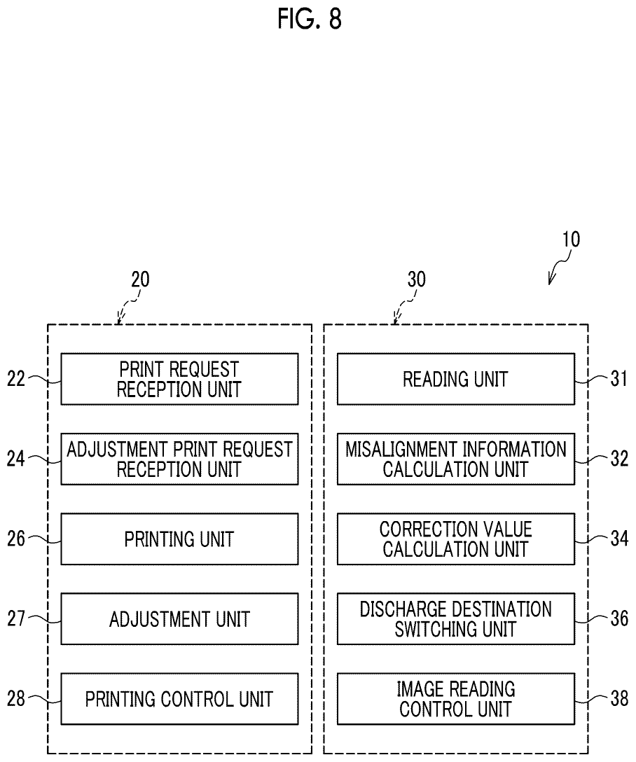

FIG. 9 is a flowchart showing the flow of a printing position adjustment process in the printing system shown in FIG. 1; and

FIG. 10 is a flowchart showing the flow of a printing position adjustment process in a modification example of the printing system according to the exemplary embodiment.

### DETAILED DESCRIPTION

Hereinafter, an exemplary embodiment will be described with reference to the drawings.

### Overview of Printing System

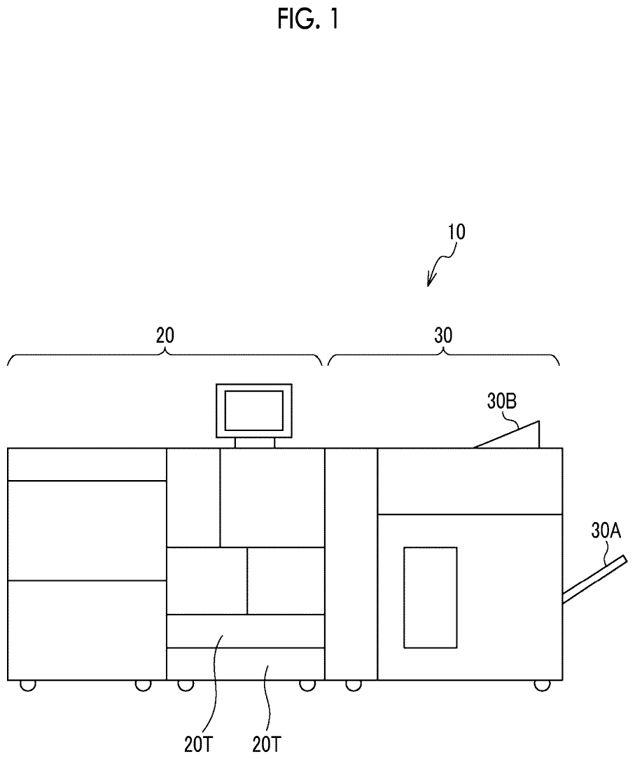

FIG. 1 shows a printing system 10 according to an exemplary embodiment. The printing system 10 includes a printer 20 and an image reader 30.

### Printer

The printer 20 includes a plurality of accommodation trays 20T that accommodate paper. In addition, the printer 20 has a printing function of printing an image (hereinafter referred to as a “print image”) on the paper supplied from the accommodation trays 20T. The printer 20 supplies the paper on which a print image is printed (hereinafter referred to as “printed material”) to the image reader 30. The paper is an example of a recording medium.

### Image Reader

The image reader 30 has an image reading function of sequentially receiving the printed material on which a print image is printed from the printer 20 and reading the print image from the received printed material. Specifically, the image reader 30 includes a scanner or the like as an inline sensor that optically reads the print image from the printed material received from the printer 20.

In addition, the image reader 30 includes an output tray 30A that discharges printed material from which a print image is read. In addition, the image reader 30 includes a purge tray 30B to which an adjustment page from which a position adjustment image M to be described later is read discharged.

### Printing Position Adjustment Function

The printing system 10 has a printing position adjustment function of adjusting (correcting) the position of a print image to be printed on paper. In the printing process for executing this printing position adjustment function, a print image for detecting the printing position of the print image printed on the paper (hereinafter referred to as a “position adjustment image”) is printed on paper. The position adjustment image is printed, for example, in the margin region of the paper to be cut. The position adjustment image M is an example of the position adjustment image.

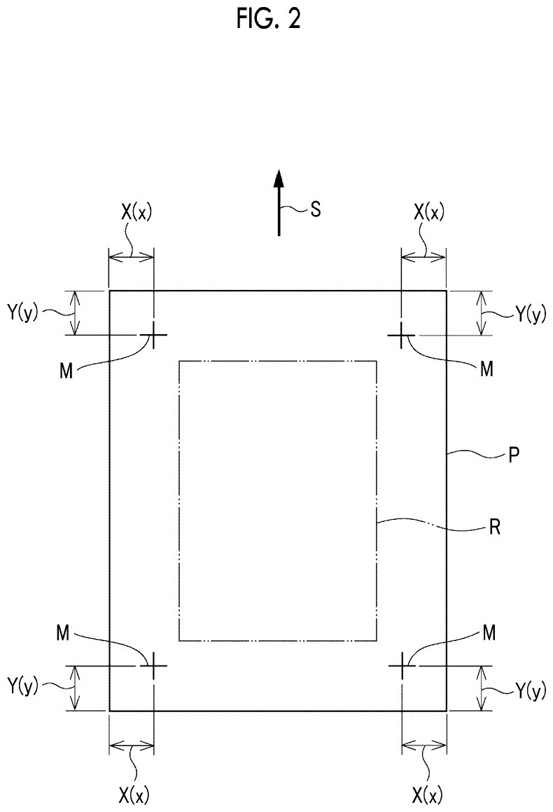

FIG. 2 shows an example of a position adjustment image M. As an example, the position adjustment image M is a cross-shaped image and is printed in each of the four corners of the margin region outside the image printing region R on paper P. In addition, each position adjustment image M is printed such that the position adjustment image M is disposed at a predetermined position (hereinafter referred to as a “target position”) on the paper P. Examples of the target position of the position adjustment image M include a predetermined distance (hereinafter referred to as “target distances X and Y”) from the outer peripheral edge of the paper P.

In two-sided printing where print images are printed on both sides of the paper P, a plurality of position adjustment images M are respectively printed on both sides of the paper P.

Each position adjustment image M printed on the paper P is read by the image reader 30. Then, the position adjustment image M read by the image reader 30 is subjected to image analysis, and the position of the position adjustment image M on the paper P (hereinafter referred to as the “detection position”) is detected. Examples of the detection position of the position adjustment image M on the paper P include the distance from the outer peripheral edge of the paper P to the position adjustment image M (hereinafter referred to as “detection distances x, y”). The misalignment information of the position adjustment image M is calculated on the basis of the detection position and the above-described target position.

Examples of the misalignment information include the lead position, the side position, the right angle correction amount, the trapezoidal correction amount, the horizontal magnification (main scanning magnification), and the vertical magnification (sub-scanning magnification). As an example, the lead position is the misalignment amount of the position adjustment image M in the transport direction of the paper P, and is calculated, for example, as the difference (X−x) between the target distance X and the detection distance x. In addition, the side position is the misalignment amount of the position adjustment image M in a direction orthogonal to the transport direction of the paper P, and is calculated, for example, as the difference (Y−y) between the target distance Y and the detection distance y.

Next, a correction value (adjustment value) for adjusting the printing position of the print image to be printed on the paper P is calculated on the basis of the calculated misalignment information. As an example, the correction value is calculated for each type of misalignment information (lead position, side position, right angle correction amount, trapezoidal correction amount, horizontal magnification, and vertical magnification) described above.

For example, the correction value for the lead position is calculated as position information indicating the printing start position of the print image with the leading edge of the paper P in the transport direction as a reference. In addition, for example, the correction value for the side position is calculated as position information indicating the printing start position of the print image with one end of the paper P in the direction orthogonal to the transport direction as a reference. The printing position of the print image to be printed on the paper P is corrected on the basis of the calculated correction value.

### Correction Continuous Printing Function

Here, in the printing system 10, in a case where a plurality of printed materials are continuously printed, the misalignment of the printing position of the print image is likely to occur due to the influence of the temperature rise of the transport mechanism for transporting the paper, and the misalignment amount of the printing position of the print image is likely to change in accordance with the temperature of the transport mechanism. Therefore, the printing system 10 according to the present exemplary embodiment includes a correction continuous printing function (real-time correction continuous printing function) for adjusting the printing position of a print image to be printed on paper while continuously printing a plurality of printed materials.

In a print job using the correction continuous printing function (hereinafter referred to as a “correction continuous print job”), while a plurality of printed materials are continuously printed, the printing position of a print image is adjusted via feedback control, on the basis of a position adjustment image printed on a preceding printed material. The correction continuous print job is an example of a print job.

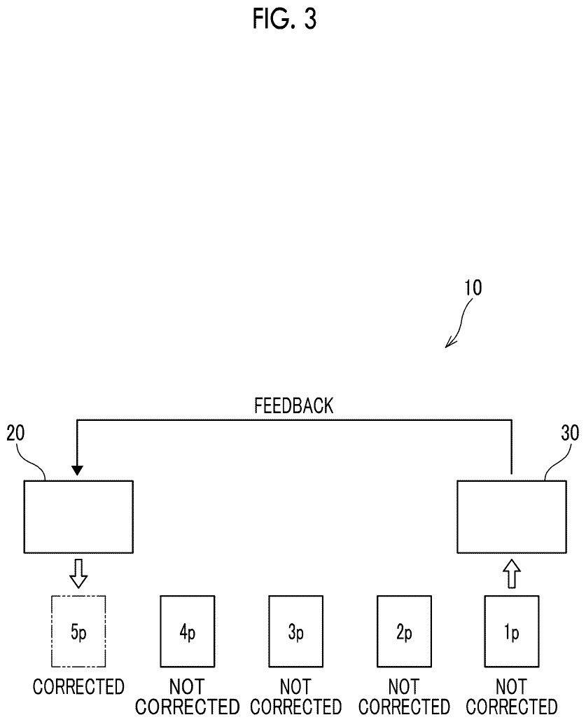

Specifically, as shown in the schematic diagram shown in FIG. 3, the printing system 10 prints the position adjustment image (refer to FIG. 2) in the margin region of the paper by using the printer 20. Then, the printing system 10 sequentially reads the position adjustment images from the preceding printed material by using the image reader 30, and calculates the misalignment information of each of the position adjustment images on the paper on the basis of the read position adjustment images.

Moreover, the printing system 10 calculates a correction value for adjusting the printing position of the print image on the basis of the calculated misalignment information, and adjusts the printing position of the print image to be printed on the paper on the basis of the calculated correction value. Accordingly, while continuously printing a plurality of printed materials, the misalignment amount of the print image to be printed on paper is reduced.

Here, in the printing system 10 shown in FIG. 3, before the image reader 30 reads the position adjustment image from the printed material of the first page (1 p) in the correction continuous print job, the printer 20 starts the printing of the printed materials of the following second page (2 p) and subsequent pages. Therefore, in the printing system 10 shown in FIG. 3, the printing position of the print image is not adjusted during the printing of the printed materials of the first to fourth pages (1 to 4 p), and the printing position of the print image is adjusted from the printed materials of the fifth page (5 p) and subsequent pages.

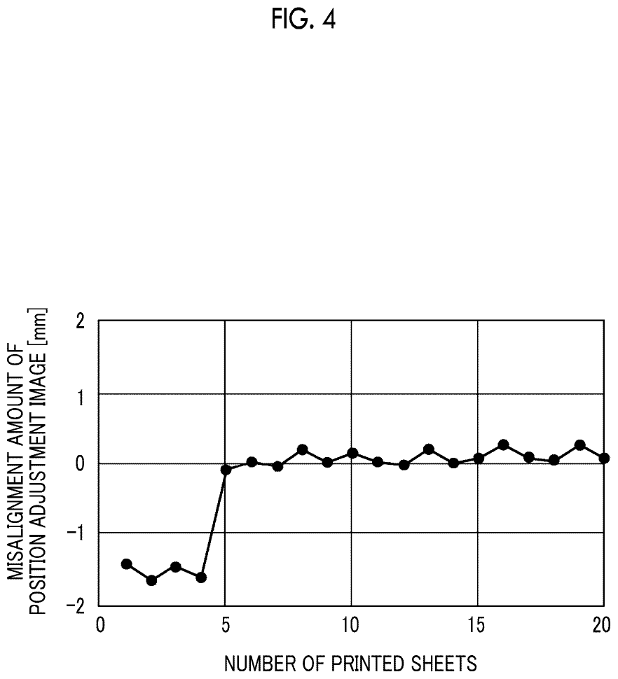

In addition, FIG. 4 shows a graph indicating the relationship between the number of printed sheets of the printed material and the misalignment amount of the position adjustment image read from the printed material by the image reader 30 in the printing system 10 shown in FIG. 3. The misalignment amount (misalignment information) of the position adjustment image is, for example, the misalignment amount (registration position) of the position adjustment image in the transport direction of the paper.

As shown in FIG. 4, in the printed materials of the first to fourth pages (1 to 4 p) where the printing position of the print image is not adjusted, the amount of misalignment of the position adjustment image is large, and in the printed materials of the fifth page (5 p) and subsequent pages where the printing position of the print image is adjusted, the amount of misalignment of the position adjustment image is small.

In a case where printing of subsequent printed material is started before the position adjustment image is read from the preceding printed material as described above, a plurality of printed materials in which the printing position of the print image is not adjusted are generated.

### Measures Against Variation in Misalignment Information

Here, in order to reduce the variation in the misalignment information of the print image, it is considered to calculate a moving average value of the plurality of pieces of misalignment information and calculate a correction value for the printing position of the print image on the basis of the calculated moving average value.

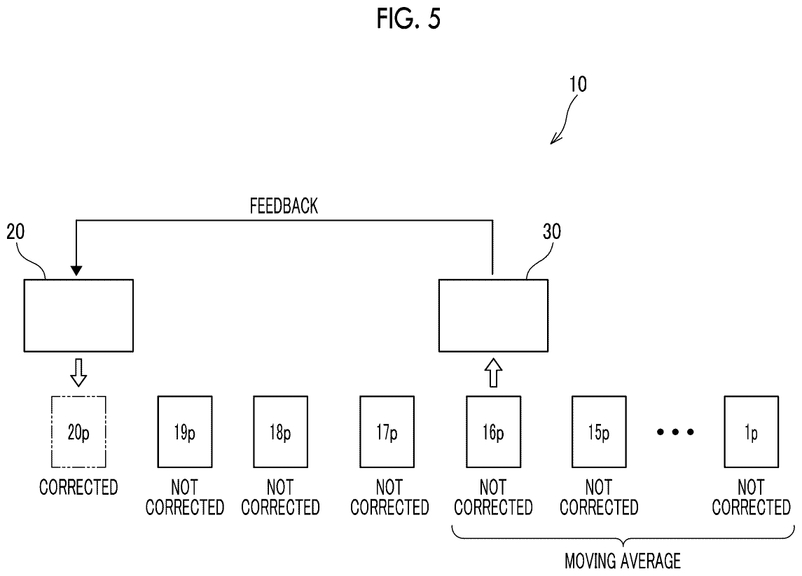

Specifically, in the printing system 10 shown in FIG. 5, the misalignment information of the position adjustment image is set as a moving average value of 16 printed materials. In this case, in the image reader 30, in a case where the number of times of reading the position adjustment image from the printed material (hereinafter referred to as “the number of times of reading”) does not reach the number of times required for calculating the moving average of the misalignment information, that is, 16, the misalignment information is not calculated, and in the printer 20, the printing position of the print image to be printed on the paper is not adjusted.

In addition, in the printing system 10 shown in FIG. 5, printing of printed materials of the following the 17th page (17 p) and subsequent pages is started in the printer 20 before the correction value is calculated. Therefore, in the printing system 10 shown in FIG. 5, the printing position of the print image is not adjusted during the printing of the printed materials of the first to 19th pages (1 to 19 p), and the printing position of the print image is adjusted from the printed materials of the 20th page (20 p) and subsequent pages.

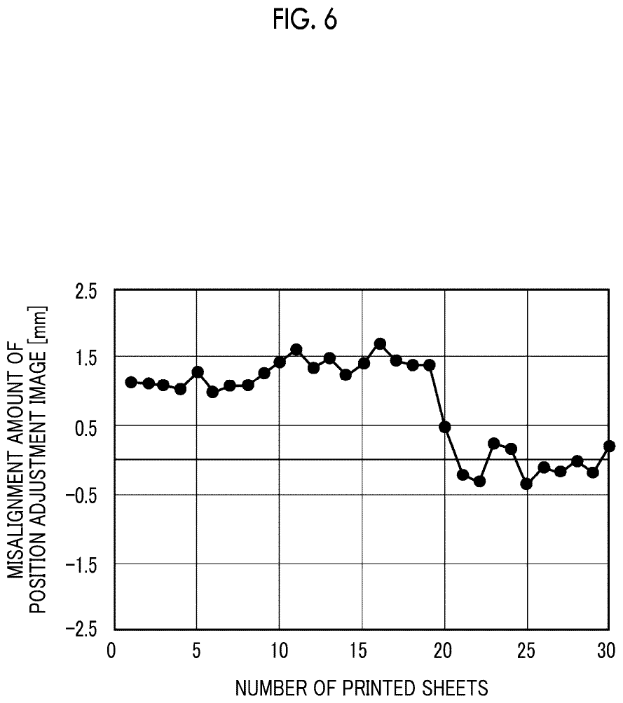

In addition, FIG. 6 shows a graph indicating the relationship between the number of printed sheets of the printed material and the misalignment amount of the position adjustment image read from the printed material by the image reader 30 in the printing system 10 shown in FIG. 5. The misalignment amount (misalignment information) of the position adjustment image is, for example, the misalignment amount (registration position) of the position adjustment image in the transport direction of the paper.

As shown in FIG. 6, in the printed materials of the first to 19th pages (1 to 19 p) where the printing position of the print image is not adjusted, the amount of misalignment of the position adjustment image is large, and in the printed materials of the 20th page (20 p) and subsequent pages where the printing position of the print image is adjusted, the amount of misalignment of the position adjustment image is small.

In this way, in a case where the moving average value of the plurality of pieces of misalignment information is calculated and the correction value for the printing position of the print image is calculated on the basis of the calculated moving average value, the number of printed materials in which the printing position of the print image is not adjusted increases.

Therefore, in the printing system 10 according to the present exemplary embodiment, before executing the correction continuous print job, the same printed material as the printed material of the first page in the correction continuous print job is printed as an adjustment page, and during the printing of the printed material of the first page in the correction continuous print job, the position of the print image to be printed on paper is adjusted on the basis of the adjustment page. Hereinafter, the printing system 10 according to the present exemplary embodiment will be described in detail.

### Hardware Configuration of Printing System

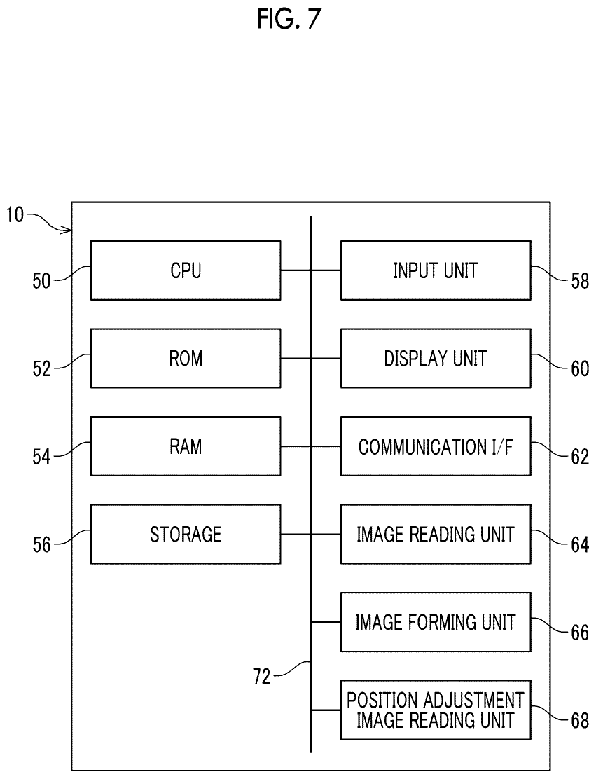

First, the hardware configuration of the printing system 10 will be described. It should be noted that, in the following, for convenience of description, a hardware configuration of the printing system 10 will be described, but the printer 20 and the image reader 30 may separately include the hardware configuration as shown in FIG. 7.

As shown in FIG. 7, the printing system 10 has components including a central processing unit (CPU) 50, a read only memory (ROM) 52, a random access memory (RAM) 54, a storage 56, an input unit 58, a display unit 60, a communication interface (I/F) 62, an image reading unit 64, an image forming unit 66, and a position adjustment image reading unit 68. The configurations are connected to each other via a bus 72 in a communicable manner.

The CPU 50 is a central processing unit and executes various programs or controls each unit. That is, the CPU 50 reads out a program from the ROM 52 or the storage 56 and executes the program using the RAM 54 as a work area. The CPU 50 controls each of the above-described configurations and performs various types of arithmetic process according to the program recorded on the ROM 52 or the storage 56. The CPU 50 is an example of a printing control unit and a processor.

The ROM 52 stores various information processing programs and various types of data. The RAM 54 temporarily stores the program or the data as the work area of the CPU 50.

The storage 56 is configured with a hard disk drive (HDD) or a solid state drive (SSD), and stores various programs including an operating system and various types of data.

The input unit 58 includes an operation button or the like and is used to perform various inputs. The display unit 60 is, for example, a liquid crystal display and displays various types of information. The display unit 60 may be a touch panel type and may function as the input unit.

The communication I/F 62 is an interface for communication with other apparatuses. For example, a standard, such as Ethernet (Registered Trademark), FDDI, or Wi-Fi (Registered Trademark), is used.

The image reading unit 64 includes a scanner or the like and optically reads image data from a document or the like. The image forming unit 66 prints the image data read by the image reading unit 64 or the image data received from an operation terminal (not shown) on a recording medium such as paper.

The position adjustment image reading unit 68 includes a scanner or the like, and optically reads, for example, the print image, such as the position adjustment image, from the paper (printed material) on which the print image is printed by the image forming unit 66.

### Function of Printing System

Next, the functions of the printing system 10 will be described.

In a case where the information processing program described above is executed, the printing system 10 implements various functions of the printer 20 and the image reader 30 by using the above hardware resources.

### Printing System

Specifically, as shown in FIG. 3, the printer 20 functionally includes a print request reception unit 22, an adjustment print request reception unit 24, a printing unit 26, an adjustment unit 27, and a printing control unit 28.

### Print Request Reception Unit

The print request reception unit 22 receives a correction continuous print job input into the printing system 10. Examples of this correction continuous print job include information (print data) about a print image and printing conditions such as paper size and the number of printed sheets.

### Adjustment Print Job Reception Unit

The adjustment print request reception unit 24 receives a print request for an adjustment page input to the printing system 10 (hereinafter referred to as an “adjustment print job”). The adjustment page is a printed material for calculating a correction value for the printing position of the print image.

The adjustment print job is input to the printing system 10, for example, in a case where the user selects the execution of the adjustment page on the selection screen displayed on the display unit 60 of the printing system 10. The adjustment print job input to the printing system 10 is received by the adjustment print request reception unit 24.

### Printing Unit

The printing unit 26 prints a print image (including a position adjustment image) on the paper on the basis of the print request for the correction continuous printing received by the print request reception unit 22.

### Adjustment Unit

The adjustment unit 27 adjusts the printing position of the print image to be printed on the paper on the basis of the correction value of the printing position of the print image calculated by the correction value calculation unit 34 described below.

### Printing Control Unit

The printing control unit 28 controls the overall operation of the printer 20. In addition, the printing control unit 28 continuously prints a plurality of printed materials while adjusting the printing position of the print image to be printed on the paper on the basis of the correction continuous print job received by the print request reception unit 22.

Specifically, the printing control unit 28 controls a paper feeding device (not shown) on the basis of the correction continuous print job received by the print request reception unit 22 to sequentially supply a plurality of sheets of paper from the accommodation tray 20T to the printing unit 26. In addition, the printing control unit 28 transmits the print data to be printed on the plurality of sheets of paper to the printing unit 26. Then, the printing control unit 28 causes the printing unit 26 to print the print image and the position adjustment image based on the print data on the plurality of sheets of paper supplied from the accommodation tray 20T, and sequentially supplies the plurality of printed materials from the printing unit 26 to the image reader 30.

### Adjustment Page

Here, in the case where the adjustment print request reception unit 24 receives the adjustment print job, the printing control unit 28 prints the adjustment page of the same print image as the printed material of the first page in the correction continuous print job before executing the correction continuous print job.

Specifically, the printing control unit 28 controls a paper feeding device (not shown) to supply the paper to the printing unit 26 from the accommodation tray 20T used for the printed material of the first page in the correction continuous print job. Accordingly, paper of the same size and type as the printed material of the first page of the correction continuous print job is supplied to the printing unit 26.

In addition, the printing control unit 28 transmits the same print data as the print data to be printed on the printed material of the first page of the correction continuous print job to the printing unit 26. Then, the printing control unit 28 causes the printing unit 26 to print the print image and the position adjustment image based on the print data on the paper supplied from the accommodation tray 20T, and supplies the printed adjustment page from the printing unit 26 to the image reader 30.

Here, the printing control unit 28 performs printing while providing an interval between the adjustment page and the first page in the correction continuous print job such that the printing position of the printed material of the first page is adjusted by the adjustment unit 27 in the correction continuous print job. Specifically, the printing control unit 28 starts the above-described correction continuous print job after receiving the correction value from the correction value calculation unit 34 of the image reader 30 described below. Accordingly, the printing position of the print image is adjusted during the printing of the printed material of the first page in the correction continuous print job.

### Image Reader

The image reader 30 functionally includes a reading unit 31, a misalignment information calculation unit 32, a correction value calculation unit 34, a discharge destination switching unit 36, and an image reading control unit 38.

### Reading Unit

The reading unit 31 optically reads the position adjustment image from the printed material printed by the printing unit 26.

### Misalignment Information Calculation Unit

The misalignment information calculation unit 32 calculates the detection position of the position adjustment image by performing the image process on the position adjustment image read by the reading unit 31. The misalignment information calculation unit 32 calculates the misalignment information of the position adjustment image on the basis of the calculated detection position of the position adjustment image and the target position.

Examples of the misalignment information of the position adjustment image include the lead position, the side position, the right angle correction amount, the trapezoidal correction amount, and the horizontal magnification, as described above. In addition, the misalignment information of the position adjustment image calculated by the misalignment information calculation unit 32 is stored in a predetermined storage region as time-series data in accordance with the number of sheets of the printed materials.

### Correction Value Calculation Unit

The correction value calculation unit 34 calculates a correction value for the printing position of a print image to be printed on paper on the basis of the misalignment information calculated by the misalignment information calculation unit 32. As described above, the correction value is calculated for each type of misalignment information (lead position, side position, right angle correction amount, trapezoidal correction amount, horizontal magnification, and vertical magnification).

### Discharge Destination Switching Unit

The discharge destination switching unit 36 switches the discharge destination of the printed material from which the position adjustment image is read between the output tray 30A and the purge tray 30B.

### Image Reading Control Unit

The image reading control unit 38 controls the overall operation of the image reader 30. Specifically, the image reading control unit 38 causes the reading unit 31 to read the position adjustment image from the printed material and causes the misalignment information calculation unit 32 to calculate the position misalignment information of the position adjustment image.

Further, the image reading control unit 38 causes the correction value calculation unit 34 to calculate the correction value for the printing position of the print image to be printed on the paper. Then, the image reading control unit 38 transmits the correction value calculated by the correction value calculation unit 34 to the printing control unit 28.

In addition, the image reading control unit 38 switches the discharge destination of the printed material between the output tray 30A and the purge tray 30B in accordance with the print job. Specifically, in a case where the print job is a correction continuous print job, the image reading control unit 38 switches the discharge destination of the printed material to the output tray 30A using the discharge destination switching unit 36. On the other hand, in a case where the print job is an adjustment print job, the image reading control unit 38 switches the discharge destination of the printed material to the purge tray 30B using the discharge destination switching unit 36.

The printing control unit 28 and the image reading control unit 38 transmit and receive information to and from each other, thereby cooperating to control the overall operation of the printing system 10.

### Printing Process of Printing System

Next, the printing process by the printing system 10 will be described.

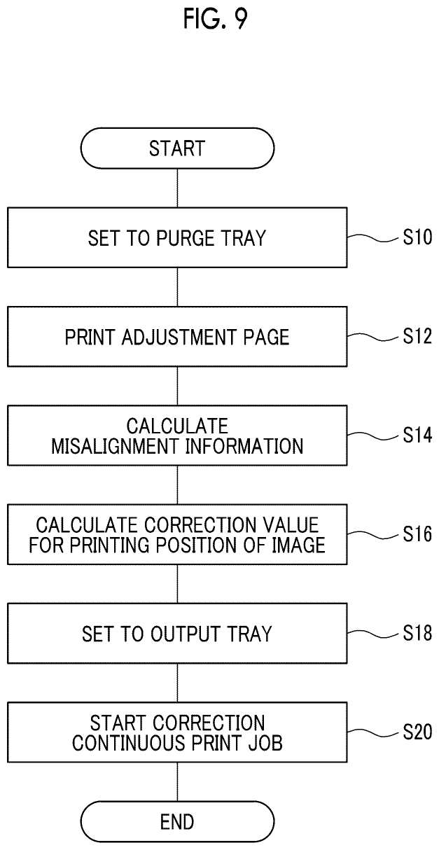

In a case where the printing system 10 receives the adjustment print job and the correction continuous print job, the printing process shown in FIG. 9 is executed in the printing system 10. The printing process is an example of a printing method.

First, in step S10, the CPU 50 sets the discharge destination of the printed material to the purge tray 30B.

Next, in step S12 as an example of the printing step, the CPU 50 prints the same printed material as the printed material of the first page in the correction continuous print job as the adjustment page. Specifically, the CPU 50 causes the printer 20 to print the adjustment page on the basis of the print data of the printed material of the first page in the correction continuous print job, and supplies the printed adjustment page to the image reader 30. In this case, the printer 20 prints the position adjustment image on the adjustment page.

Next, in step S14, the CPU 50 calculates the misalignment information of the position adjustment image, on the basis of the position adjustment image read from the adjustment page. Specifically, as an example of the reading step, the CPU 50 causes the image reader 30 to read the position adjustment image from the adjustment page and discharge the adjustment page to the purge tray 30B. In this case, the CPU 50 calculates the misalignment information of the position adjustment image on the basis of the position adjustment image read by the image reader 30.

Next, in step S16, the CPU 50 calculates the correction value for the printing position of the print image to be printed on paper on the basis of the calculated misalignment information of the position adjustment image. That is, the CPU 50 calculates a correction value (initial value) for adjusting the printing position of a print image to be printed on the paper during the printing of the printed material of the first page in the correction continuous print job.

Next, in step S18, the CPU 50 sets the discharge destination of the printed material to the output tray 30A.

Next, in step S20 as an example of the instruction step, the CPU 50 starts the correction continuous print job. That is, the CPU 50 performs printing while providing an interval between the adjustment page and the first page in the correction continuous print job such that the printing position of the printed material of the first page is adjusted in the correction continuous print job.

Specifically, the CPU 50 causes the printer 20 to sequentially print a plurality of printed materials on the basis of the print data of the correction continuous print job, and supplies the plurality of printed materials to the image reader 30. In this case, the printer 20 prints the position adjustment image on the printed material.

In addition, the CPU 50 adjusts the printing position of the print image to be printed on the paper on the basis of the correction value calculated in step S16. That is, as an example of the adjustment step, the CPU 50 adjusts the printing position of the print image to be printed on the paper on the basis of the adjustment image read from the adjustment page during the printing of the printed material of the first page in the correction continuous print job.

The position adjustment images of the plurality of printed materials are sequentially read by the image reader 30, and then the printed materials are discharged to the output tray 30A. In this case, the CPU 50 calculates the misalignment information of the position adjustment image on the basis of the position adjustment image read by the image reader 30 and calculates the correction value for the printing position of the print image to be printed on the paper on the basis of the calculated misalignment amount.

Accordingly, each time the image reader 30 reads the position adjustment image from the printed material, the correction value for the printing position of the print image to be printed on the paper is updated, thereby reducing the shift amount of the printing position of the print image.

It should be noted that, until the correction value on the basis of the position adjustment image read from the printed material of the first page in the correction continuous print job is calculated, the printing position of the print image to be printed on the paper is adjusted on the basis of the correction value (initial value) calculated in step S16.

### Modification Example

Next, modification examples of the above-described exemplary embodiment will be described.

In a case where the adjustment print job is received, the printing system 10 according to the exemplary embodiment prints an adjustment page. However, the printing system 10 may be configured to print the adjustment page before executing the correction continuous print job, for example, in the case of receiving the correction continuous print job, without being limited to the case of receiving the adjustment print job.

In addition, for example, in a case where the first correction continuous print job is received after the printing system 10 is started, the printing system 10 may be configured to print the adjustment page before executing the correction continuous print job. In addition, the printing system 10 may be configured to print the adjustment page before executing the subsequent correction continuous print job in a case where printing conditions, such as the size and type of the paper, are different between the plurality of correction continuous print jobs which are continuous, or may be configured to not print the adjustment page before executing the subsequent correction continuous print job in cases where the printing conditions are the same.

In addition, in the above-described exemplary embodiment, the same printed material (the adjustment page) as the printed material of the first page in the correction continuous print job is printed as the adjustment page. However, the printing system 10 may print the printed material of the first page in the correction continuous print job as the adjustment page.

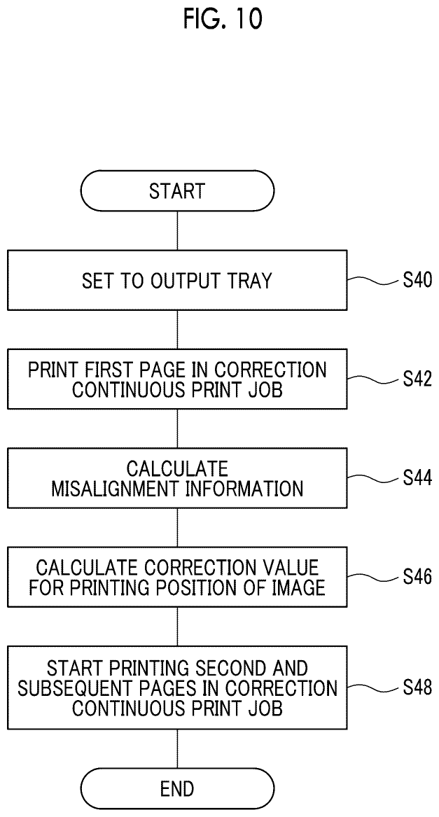

Specifically, for example, in a case where the printing system 10 receives the correction continuous print job, the printing system 10 may execute the printing process shown in FIG. 10. In this printing process, as an instruction step, the CPU 50 instructs the printing of the entire print job such that the printing of the second and subsequent pages in the print job is performed after adjusting the printing position of the second page in the print job based on the position adjustment image read from the first page in the print job. The printing process is an example of a printing method.

First, in step S40, the CPU 50 sets the discharge destination of the printed material to the output tray 30A.

Next, in step S42 as an example of the printing step, the CPU 50 prints the printed material of the first page in the correction continuous print job as the adjustment page. Specifically, the CPU 50 causes the printer 20 to print only the printed material of the first page in the correction continuous print job, and supplies the printed material of the first page on which a print image is printed to the image reader 30. In this case, the printer 20 prints the position adjustment image on the printed material of the first page in the correction continuous print job.

Next, in step S44, the CPU 50 calculates the misalignment information of the position adjustment image on the basis of the position adjustment image read from the printed material of the first page. Specifically, as an example of the reading step, the CPU 50 causes the image reader 30 to read the position adjustment image from the printed material of the first page and causes the printed material of the first page to be discharged to the output tray 30A. In this case, the CPU 50 calculates the misalignment information of the position adjustment image on the basis of the position adjustment image read by the image reader 30.

Next, in step S46, the CPU 50 calculates the correction value for the printing position of the print image to be printed on the paper on the basis of the calculated misalignment information of the position adjustment image. That is, the CPU 50 calculates a correction value (initial value) for adjusting the printing position of the print image during the printing of the printed material of the second page in the correction continuous print job.

Next, in step S48, the CPU 50 starts printing the second and subsequent pages in the correction continuous print job. That is, the CPU 50 performs printing while providing an interval between the first page and the second page in the correction continuous print job such that the printing positions of the second and subsequent pages in the correction continuous print job are adjusted.

Specifically, the CPU 50 causes the printer 20 to sequentially print the printed materials of the second and subsequent pages in the correction continuous print job, and supplies the printed materials of the second and subsequent pages on which a print image is printed to the image reader 30. In this case, the printer 20 prints the position adjustment image on the printed materials of the second and subsequent pages in the correction continuous print job.

In addition, as an example of the adjustment step, the CPU 50 adjusts the printing position of the print image to be printed on the second page in the correction continuous print job on the basis of the correction value calculated in step S46. That is, the CPU 50 adjusts the printing position of the print image to be printed on the paper on the basis of the adjustment image read from the first page in the correction continuous print job during the printing of the printed material of the second page in the correction continuous print job.

The position adjustment images of the plurality of printed materials are sequentially read by the image reader 30, and then the printed materials are discharged to the output tray 30A. In this case, the CPU 50 calculates the misalignment information of the position adjustment image on the basis of the position adjustment image read by the image reader 30 and calculates the correction value for the printing position of the print image to be printed on the paper on the basis of the calculated misalignment amount.

Accordingly, each time the image reader 30 reads the position adjustment image from the printed material, the correction value for the printing position of the print image to be printed on the paper is updated, thereby reducing the shift amount of the printing position of the print image.

It should be noted that, until the correction value on the basis of the position adjustment image read from the printed material of the second page in the correction continuous print job is calculated, the printing position of the print image to be printed on the paper is adjusted on the basis of the correction value (initial value) calculated in step S46.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In the above exemplary embodiment, the form in which each program is installed in the ROM or the storage has been described, but the present invention is not limited thereto. Each program according to the above exemplary embodiment may be provided in the form of a recording on a computer readable storage medium. For example, each program according to the above exemplary embodiment may be provided in the form of a recording on an optical disc such as a compact disc (CD)-ROM and a digital versatile disc (DVD)-ROM or in the form of a recording on a semiconductor memory such as a universal serial bus (USB) memory and a memory card. Further, each program according to the above-described exemplary embodiment may be acquired from an external apparatus via a communication I/F.

In addition, in the exemplary embodiment described above, a case where the processing in the printing system 10 is implemented by a software configuration by using a computer by executing a program is described, but the present disclosure is not limited thereto. For example, the processing in the printing system 10 may be implemented by a hardware configuration or a combination of the hardware configuration and the software configuration.

Further, needless to say, the configuration of the printing system 10 described in the exemplary embodiment described above is an example, and an unnecessary part may be deleted or a new part may be added without departing from the gist of the present disclosure.

In addition, needless to say, the flow of the processes in the printing system 10 described in the above exemplary embodiment is also an example, and an unnecessary step may be deleted, a new step may be added, or processing order may be changed without departing from the gist of the present disclosure.

The following supplementary notes are further disclosed regarding the above-described exemplary embodiment.
(((1)))

A printing system comprising:
a printing unit that prints a print image on a recording medium and prints a position adjustment image corresponding to each page of the print image on the recording medium;
a reading unit that reads the position adjustment image printed by the printing unit;
an adjustment unit that adjusts a printing position of each page of the print image printed by the printing unit on the recording medium on the basis of the position adjustment image read by the reading unit; and
a printing control unit that performs control to perform printing while providing an interval between a printing timing of a first page and a printing timing of a second page of the print image such that a printing position of the second page of the print image is adjusted by the adjustment unit on the basis of the position adjustment image of the first page of the print image.
(((2)))

A printing system comprising:
a printing unit that prints a print image on a recording medium and prints a position adjustment image corresponding to each page of the print image on the recording medium;
a reading unit that reads the position adjustment image printed by the printing unit;
an adjustment unit that adjusts a printing position of each page of the print image printed by the printing unit on the recording medium on the basis of the position adjustment image read by the reading unit; and
a printing control unit that generates an adjustment page of the same image as a first page of the print image and performs printing while providing an interval between the adjustment page and the first page of the print image such that a printing position of the first page of the print image is adjusted by the adjustment unit on the basis of the position adjustment image of the adjustment page.
(((3)))

The printing system according to (((2))),
wherein the recording medium on which the adjustment page is printed is discharged to a purge tray.
(((4)))

A printing method comprising:
printing a first page in a print job on a recording medium and printing a position adjustment image on the recording medium;
reading the position adjustment image printed in the printing;
adjusting a printing position at which a second page in the print job is printed on the recording medium based on the position adjustment image read in the reading; and
giving an instruction to print an entire print job such that printing of the second and subsequent pages in the print job is performed after the printing position is adjusted in the adjusting.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A printing system comprising:
a printing unit that prints a print image on a recording medium and prints a position adjustment image corresponding to each page of the print image on the recording medium;
a reading unit that reads the position adjustment image printed by the printing unit;
an adjustment unit that adjusts a printing position of each page of the print image printed by the printing unit on the recording medium on the basis of the position adjustment image read by the reading unit; and
a printing control unit that performs control to perform printing while providing an interval between a printing timing of a first page and a printing timing of a second page of the print image such that a printing position of the second page of the print image is adjusted by the adjustment unit on the basis of the position adjustment image of the first page of the print image.

2. A printing system comprising:
a printing unit that prints a print image on a recording medium and prints a position adjustment image corresponding to each page of the print image on the recording medium;
a reading unit that reads the position adjustment image printed by the printing unit;
an adjustment unit that adjusts a printing position of each page of the print image printed by the printing unit on the recording medium on the basis of the position adjustment image read by the reading unit; and
a printing control unit that generates an adjustment page of the same image as a first page of the print image and performs printing while providing an interval between the adjustment page and the first page of the print image such that a printing position of the first page of the print image is adjusted by the adjustment unit on the basis of the position adjustment image of the adjustment page.

3. The printing system according to claim 2,
wherein the recording medium on which the adjustment page is printed is discharged to a purge tray.

4. A printing method comprising:
printing a first page in a print job on a recording medium and printing a position adjustment image on the recording medium;
reading the position adjustment image printed in the printing;
adjusting a printing position at which a second page in the print job is printed on the recording medium based on the position adjustment image read in the reading; and
giving an instruction to print an entire print job such that printing of the second and subsequent pages in the print job is performed after the printing position is adjusted in the adjusting.
